(19) United States
(12) Patent Application Publication
(10) Pub. No.: US 2008/0304444 A1
(43) Pub. Date: Dec. 11, 2008

(54) Enhanced Site Report for Low Latency Roaming By Passive Scanning in Ieee 802.11 Networks

(75) Inventor: Amjad Soomro, Hopewell Junction, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,797

(22) PCT Filed: Jul. 7, 2005
(86) PCT No.: PCT/IB2005/052272

§ 371 Date: Jan. 8, 2007

Related U.S. Application Data
(60) Provisional application No. 60/586,945, filed on Jul. 9, 2004.
(60) Provisional application No. 60/635,685, filed on Dec. 13, 2004.

(51) Int. Cl. H04Q 7/00

(52) U.S. Cl. 370/329

(57) ABSTRACT

In order to reduce the average wait time, information regarding radar presence, a component of channel availability, may be obtained through an apparatus and method for determining available channels in a wireless network. This includes determining available channels in a wireless network by: receiving regulatory domain information within the wireless network; generating a report with at least one component corresponding to the regulatory domain information; transmitting the report; receiving the report at a STA; and determining whether a channel is available for transmission based, at least in part, on the component corresponding to said regulatory domain information contained in the report.

This application claims the benefits of provisional application Ser. No. 60/586,945, filed on Jul. 9, 2004, the teachings of which are incorporated herein by reference.

The IEEE 802.11 standard specifies the medium access control (MAC) and physical characteristics for a wireless local area network (WLAN) to support physical layer units. The IEEE 802.11 standard is defined in International Standard ISO/IEC 8802-11, “IEEE Standard for Information technology—Telecommunications and information exchange between systems—Local and metropolitan area networks-Specific requirements, Part 11: Wireless LAN Medium Access Control (MAC) and Physical Layer (PHY) specifications,” 1999 Edition [1], which is hereby incorporated by reference as if fully set forth herein. The following supplements to 802.11 are also herein incorporated by reference: IEEE 802.11h, IEEE TGk draft D 0.14, and IEEE TGe draft D8.0.

In certain regulatory domains, a station (STA) is not allowed to transmit frames in certain frequency bands until it determines that no radar exists in the band of interest, or it has been informed that radars of interest are not detected by an access point (AP). If the AP finds radar, it will report to the station, which will then shut the network in that channel and move to another channel. This movement is performed following 802.11 channel scanning procedure.

IEEE TGk, previously incorporated by reference, provides for WLAN roaming capability. This specification provides for scanning for radar to a fixed number of channels, i.e., the system will scan channels in a certain range that are permitted. To assist the system in scanning, a wireless station receives reports such as a Site Report or Neighbor Report collected from the APs that says which channels are available in the station's neighborhood. This reduces the amount of scanning required to determine available channels and minimizes a lag in transmission time.

Stations may have no capacity to detect radar themselves. In such regulatory domains, stations perform passive scanning to wait for beacons from access points. The beacons contain information whether radar is present in a channel or not. The beacons are transmitted at regular fixed intervals of time and are normally spaced farther apart for networking efficiency reasons. This has the drawback that when a station switches channels during roaming, it cannot transmit until it scans for radar or listens for beacons that contain radar information. This scanning for radar and/or listening for beacons leads to longer average wait times for stations performing passive scanning, up to one beacon period per scanned channel.

Thus, in order to reduce the average wait time, information regarding radar presence, a component of channel availability, must be obtained through alternate means.

The present invention is directed to an apparatus and method for determining available channels in a wireless network. In one aspect one method for determining available channels in a wireless network involves the steps of: receiving regulatory domain information within the wireless network; generating a report comprising at least one component corresponding to the regulatory domain information; transmitting the report; receiving the report at a STA; and determining whether a channel is available for transmission based, at least in part, on the component corresponding to said regulatory domain information contained in the report.

In one embodiment, the receiving step includes receiving regulatory domain information on a system level.

In another embodiment, the receiving step includes receiving the regulatory domain information wirelessly, through a wired system, or both.

In another embodiment, the transmitting step includes transmitting the report at an interval of time shorter than the interval of time between subsequent beacon transmissions.

In another embodiment, the transmitting step includes transmitting the report independent of beacon transmissions.

In another embodiment, the transmitting step includes transmitting the report from an AP when solicited by a STA.

In another embodiment, the transmitting step includes an unsolicited transmission of the report.

In another embodiment, the method includes transmitting in the channel based on the determining step.

In another embodiment, the report includes information on a collection of APs that are candidates to which an STA can roam.

In another embodiment, the report includes information on a collection of APs that are candidates to which an STA would prefer to roam.

In another embodiment, the generating step includes generating a report including at least one component corresponding to the regulatory domain information and at least one component corresponding to radar presence.

In another embodiment, the determining step includes determining whether a channel is available for transmission based, at least in part, on the component corresponding to regulatory domain information and the component corresponding to radar presence contained in the report.

In another aspect, a method for determining available channels in a wireless network includes the steps of: receiving regulatory domain information within the wireless network; generating a report including at least one component corresponding to regulatory domain information and at least one component corresponding to radar presence; transmitting the report; receiving the report at a STA; and determining whether a channel is available for transmission based, at least in part, on the component corresponding to regulatory domain information and the component corresponding to radar presence contained in the report.

In another aspect, a method for determining available channels in a wireless network includes the steps of: collecting regulatory domain information in at least one channel at an AP; generating a protocol frame format with at least one component corresponding to said regulatory domain information; transmitting the protocol frame format; and determining whether a channel is available for transmission based, at least in part, on the component corresponding to said regulatory domain information contained in the protocol frame format.

In one embodiment, the collecting step includes collecting regulatory domain information measuring at least one channel, retrieving regulatory information from a local database, or applying regulatory rules on the results of the radio measurement.

In another embodiment, the collecting step occurs through a wired network or through a wireless network.

In another embodiment, the transmitting step includes the AP transmitting the protocol frame format independent of regular beacons, either upon request by a STA or unsolicited.

In another aspect a system for determining available channels in a wireless network includes: a memory containing regulatory domain information; a transmission device for transmitting the regulatory domain information within the wireless network; a receiver for receiving the regulatory domain information; a report generator which generates a report containing at least one component corresponding to the regulatory domain information; a transmitter for transmitting the report; a STA for receiving the report; and a processor for determining whether a channel is available for transmission based, at least in part, on the component corresponding to the regulatory domain information contained in the report.

In another aspect, a system for determining available channels in a wireless network includes: a memory containing regulatory domain information; a transmission device for transmitting the regulatory domain information within the wireless network; a receiver for receiving the regulatory domain information; a detector for detecting the presence of radar; a report generator which generates a report containing at least one component corresponding to the regulatory domain information and at least one component corresponding to radar presence; a transmitter for transmitting the report; a STA for receiving the report; and a processor for determining whether a channel is available for transmission based, at least in part, on the component corresponding to the regulatory domain information and the component corresponding to radar presence.

The invention provides many advantages, some of which are elucidated with reference to the embodiments below.

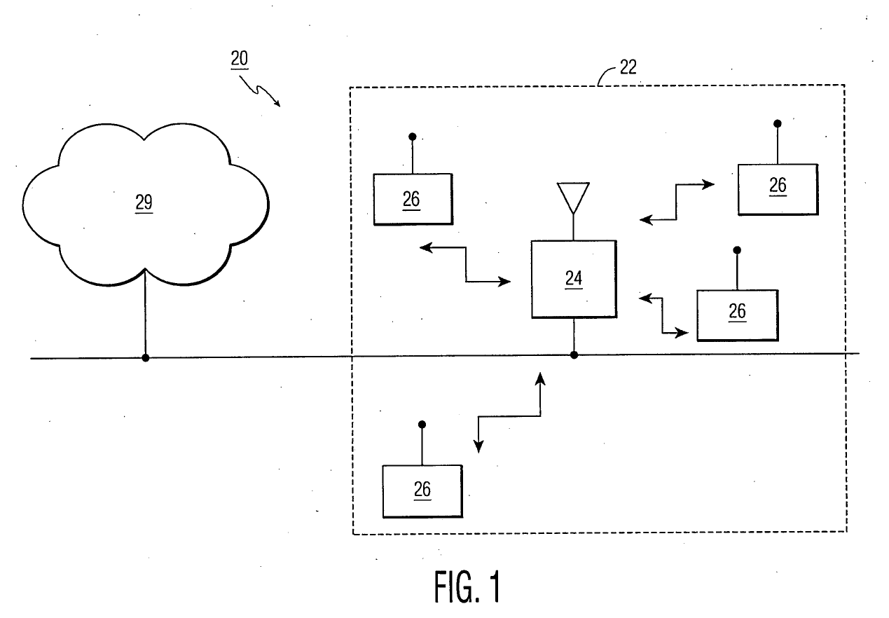

FIG. 1 depicts a WLAN;

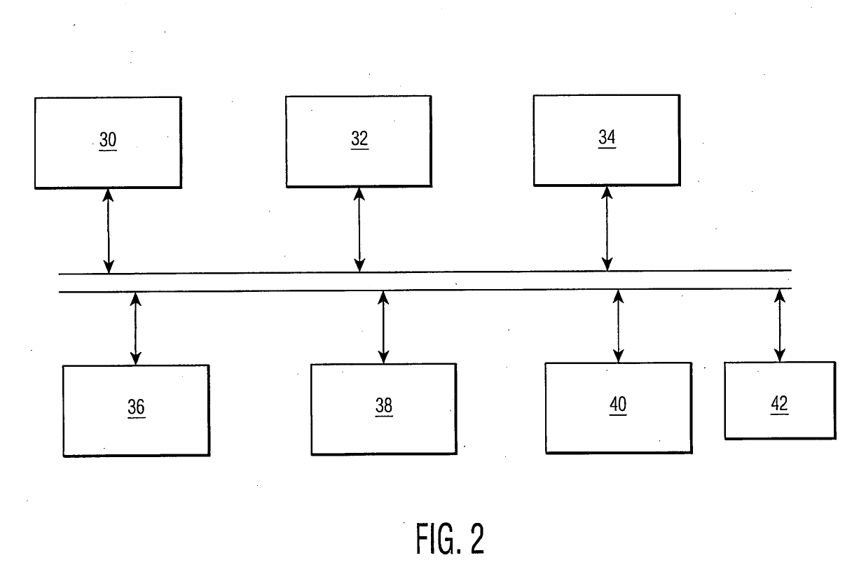

FIG. 2 illustrates a simplified block diagram of an access point (AP) and each station (STA) within a cell according to the embodiment of the present invention;

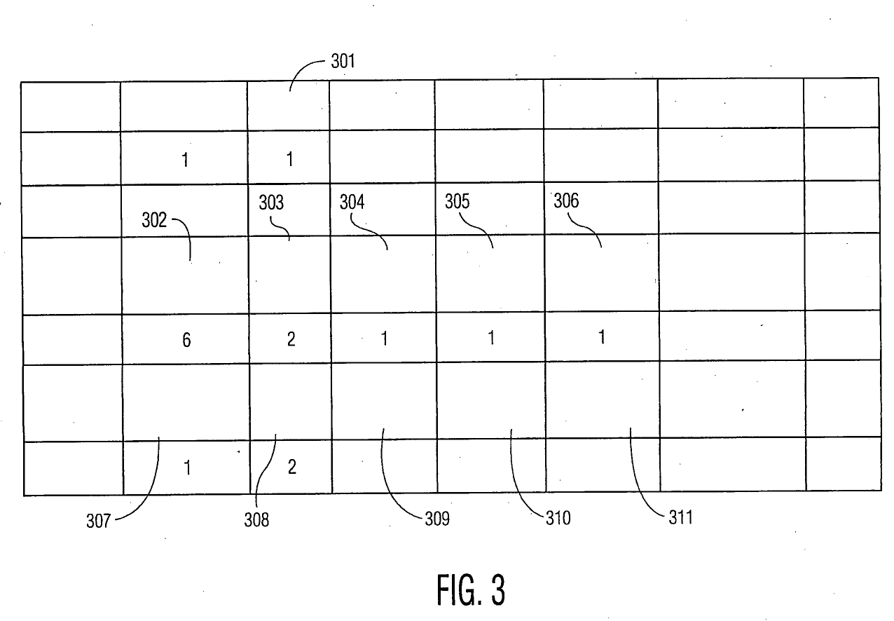

FIG. 3 depicts a Site Report element;

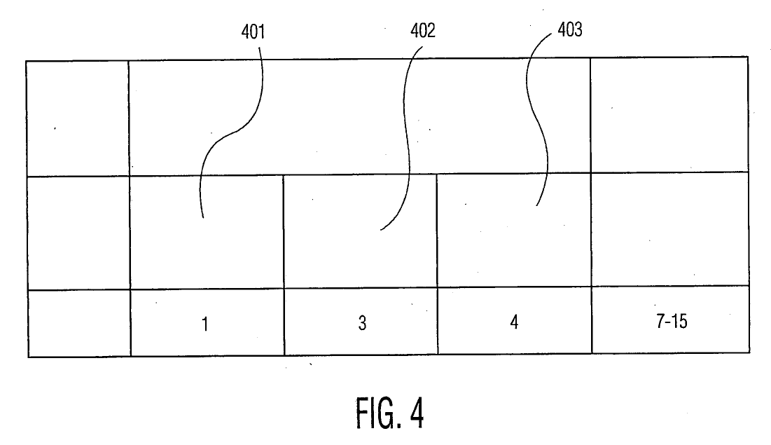

FIG. 4 depicts a BSSID Match Status field;

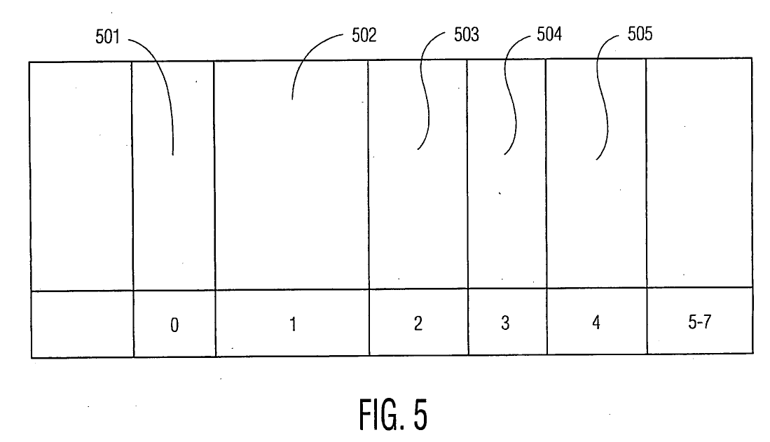

FIG. 5 depicts a Signal/Map field;

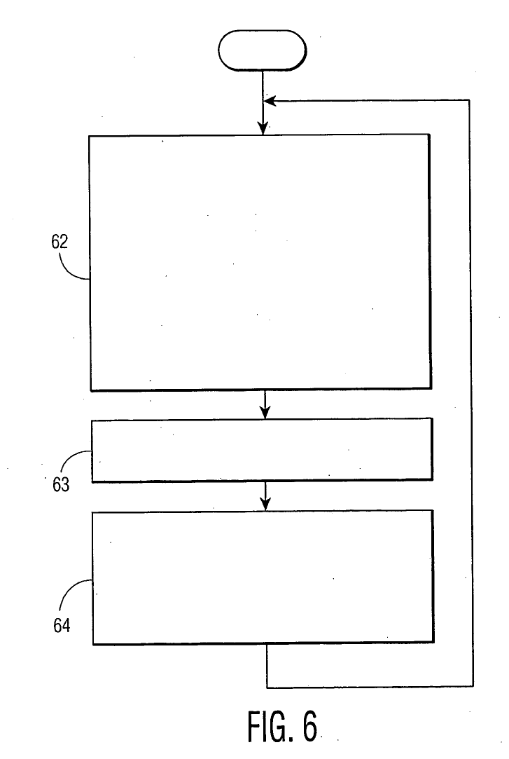

FIG. 6 depicts a process flowchart at AP for low latency scanning using regulatory information frames; and

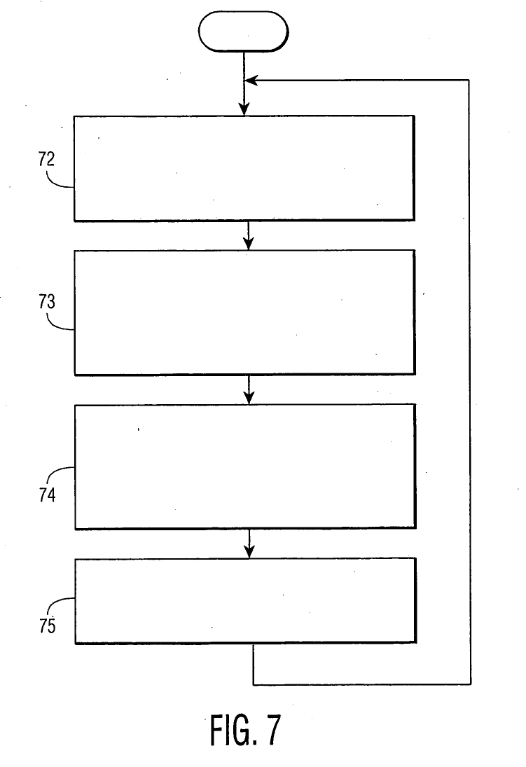

FIG. 7 depicts process flowchart at STA for low latency scanning using regulatory information frames.

FIG. 1 illustrates one example of a wireless LAN (WLAN) 20 system for implementing the method of the invention. Wireless LAN 20 defines an infrastructure network which includes a plurality of cells 22. Cell 22 includes an access point (AP) 24 (which is sometimes referred to as a wireless local bridge or a base station).

With continued reference to FIG. 1, cell 22 may include remote network stations (STAs) 26. Access point 24 and remote STAs 26 may be the transmitters and receivers of the system. Each STA 26 may be a mobile, portable, or stationary terminal. Each STA 26 may be a desktop workstation, laptop computer, palm top computer, handheld personal computer, pen-based computer, personal digital assistant, handheld scanner, data collector, handheld printer, etc.

If present, AP 24 may be an interface for communicating between wireless network 20 and a wireline network. AP 24 may be configured to provide a communications gateway between STAs 26 and AP 24 that are in cell 22 and also between a wireline network and the STAs 26. AP 24 is typically configured to convert signals between wireline and wireless communications mediums. The conversion may allow the access point to pass communication information between the wireline network and wireless STAs 26. The wireline network may be coupled to an external network 29 (e.g., PBX, PSTN, Internet, etc.).

Referring now to FIG. 2, both the AP 24 and STAs 26 may include a display 30, a CPU 32, a transmitter/receiver 34, an input device 36, a storage module 38, a random access memory (RAM) 40, a read-only memory (42), and a common bus 41. Although the description may refer to terms commonly used in describing particular computer systems, the description and concepts equally apply to other processing systems, including systems having architectures dissimilar to that shown in FIG. 2. The transmitter/receiver 34 is coupled to an antenna (not shown) to transmit desired data and its receiver converts received signals into corresponding digital data. The CPU 32 operates under the control of an operating system contained in the ROM 42 and utilizes RAM 40 to perform the frequency selection within a wireless local area network (WLAN), by enabling the AP in an infrastructure network or a STA in an ad-hoc network, to provide a new channel or wireless link for the rest of stations (STAs).

In operation, in a typical 802.11-based wireless local area network (WLAN), such as wireless LAN 20 of FIG. 1, a plurality of STAs 26 may be associated with AP 24 if present. Each STA 26 may have different communications capabilities and requirements. AP 24 may manage the communications traffic between STAs 26 and the wireline network. AP 24 may manage the communications traffic by controlling when frames are transmitted to each remote STA 26 in cell 22. The communications traffic in cell 22 may include data frames (e.g., signals that carry frames to provide data communications), voice frames (e.g., signals that carry frames to provide voice communications), real-time frames (e.g., signals that carry frames to provide real-time communications such as multimedia or voice communications), management frames (e.g., signals that carry frames to provide network management communications), etc.

AP 24 may broadcast or transmit a report such as a Site Report or Neighbor report in Site Report protocol frames. Regulatory domain information may be included in and conveyed with the report. FIG. 3 depicts a Site Report element that contains pertinent information on a collection of APs that are candidates to which STAs can roam. The information includes an element ID field 300 and a Length field 301. The Length field 301 is variable and set to the number of the quadruplets 302-311 that follow multiplied by the size of the quadruplet (i.e., 10 in FIG. 3). Each quadruplet describes an AP 24 and consists of a Basic Service Set ID (BSSID 302, BSSID Match Status 303, Current Channel 304, and PHY Type 306. The minimum value of the Length field is 0. This occurs when no neighbor AP exists in the Site Report element. Site Report element transmission may be solicited or unsolicited by STAs. It may also occur between the beacon frames.

BSSID 302 is the address of the STA 26 contained in the AP 24. The subsequent fields, including BSSID Match Status 303, Current Channel 304, and PHY Type 306 are presumed to be for corresponding BSSID.

BSSID Match Status 303 is, for example, a two-octet field containing the information shown in FIG. 4. FIG. 4 depicts the BSSID Match Status field 303. BSSID Match Status 303 is, for example, a two-octet field containing an ESS bit 401, a Capability bit 402, and a Supported Rates bit 403. ESS bit 401, if set, indicates that the AP represented by BSSID 302 advertises the same SSID as the current AP. If the bit is not set, it indicates that either the SSID does not match, or the AP does not have that information at the current time. The Capability bit 402, if set, indicates that the current AP's capabilities match that of the AP represented by BSSID 302. If the Capability bit 402 is not set, it indicates that either the capabilities do not match, or the information is not available to the AP at this time. Supported Rates bit 403, if set, indicates that the AP represented by BSSID 302 advertised Supported Rates matches the Supported Rates of the current AP. If Supported Rates bit 403 is not set, this indicates that either the Supported Rates do not match, or the information is not available to the AP at this time.

Returning to the Site Report of FIG. 3, Current Channel field 304 specifies the current operation channel of AP 24.

Channel Band field 305 contains an enumerated value from a table which specifies the frequency band in which the Current Channel is valid. This information is generated from a table outlined in TGk draft D1.0 Table kl, previously incorporated by reference, from which APs can specify bands in which the Current Channel is valid.

PHY Type field 306 represents the PHY type of the AP 24 represented by BSSID. IF the BSSID has more than one PHY type there will be a duplicate BSSID entry in the Site Report.

Maximum Transit Power Level field 307 is, for example, one octet in length. It indicates the maximum power, for example in dBm, allowed to be transmitted in the system.

Local Power Constraint field 308 is set to a value that allows mitigation requirements to be satisfied in the current channel. It is coded, for example, as an unsigned integer in units of dB. The local maximum transmit power for a channel is defined, e.g., as the Maximum Transmit Power Level specified for the channel in a Country element (not shown) minus the Local Power Constraint specified for the channel (for the MIB) in the Power Constraint element.

Signal/Map field 309 is coded as a bit field. FIG. 5 depicts Signal/Map field 309 that contains a BSS bit 501, an OFDM Preamble bit 502, an Unidentified Signal bit 503, a Radar bit 504, and an Unmeasured bit 505.

BSS bit 501 can be set equal to 1 when at least one valid MAC Protocol Data Unit (MPDU) was received in the channel during the measurement period from another BSS or IBSS. Otherwise the bit is set equal to 0.

OFDM Preamble bit 502 can be set equal to 1 when at least one sequence of short training symbols, as defined in IEEE 802.11-1999 Reaf 2003 section 17.3.3, was detected in the channel during the measurement period without a subsequent valid Signal field. This may indicate the presence of an OFDM preamble, such as HIPERLAN/2. Otherwise, the OFDM Preamble bit is set equal to 0.

Unidentified Signal bit 503 can be set equal to 1 when significant power is detected in the channel during the measurement period that cannot be characterized as radar, an OFDM preamble, or a valid MPDU. Otherwise, the Unidentified Signal bit is set equal to 0. The definition of significant power is implementation dependent.

Radar bit 504 can be set equal to 1 when radar was detected operating in the channel by the system during a measurement period. The algorithm to detect radar satisfies regulatory requirements in a given region and is beyond the scope of the TGk standard. If no radar was detected during the measurement period, the Radar bit is set to equal 0.

Unmeasured bit 505 can be set equal to 1 when this channel ahs not been measured. Otherwise it is set equal to 0. When the Unmeasured bit 505 is set equal to 1, all the other fields in Signal/Map field 309 are set to equal 0.

A subset of the information elements, or a subset of the fields, or a subset of the bits within the fields, or a combination thereof could be used in the proposed protocol frame. Additionally, the length of the fields is given as an example only. The field lengths could be made fixed or variable, or the byte count changed to accommodate different ranges of information known in the art.

FIG. 6 depicts a process flowchart at AP for low latency scanning using regulatory information frames. In this illustrative example, in step 62, an AP collects the regulatory information about the channel it is operating in and about the channel in which other APs are operating. The AP could collect this information by doing measurements on the channels, by retrieving regulatory information from a local database or by application of regulatory rules on the results of the radio measurement. The AP could also get the regulatory information through a wired network or through a wireless network. The AP then generates a protocol frame format with regulatory information in it in step 63. The AP then transmits the protocol frame format independent of the regular beacons in step 64. The AP could transmit this frame either upon request by a STA or it could transmit to at least one STA unsolicited.

FIG. 7 depicts process flowchart at STA for low latency scanning using regulatory information frames. In this illustrative example, a STA requests some regulatory information about at least one AP in the same or other channels in step 72. This step is optional and a STA may not do this step. When an AP transmits regulatory information, as stated in the previous paragraph, the STA receives this information in step 73 and decides based, at least in part, on the received information which AP to associate with, re-associate with, roam to or stay with the current AP in step 74. If a STA decides to roam to an AP about which it received information from the AP in the report, it then starts association or re-association process with that AP in step 75.

The present invention has been described with respect to particular illustrative embodiments. It is to be understood that the invention is not limited to the above-described embodiments and modifications thereto, and that those of ordinary skill in the art may make various changes and modifications without departing from the spirit and scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

What is claimed is:

1. A method for determining available channels in a wireless network comprising:
receiving regulatory domain information within the wireless network;
generating a report comprising at least one component corresponding to said regulatory domain information;
transmitting said report;
receiving said report at a STA 26; and
determining whether a channel is available for transmission based, at least in part, on said component corresponding to said regulatory domain information contained in said report.

2. The method of claim 1, wherein the receiving step further comprises receiving regulatory domain information on a system level.

3. The method of claim 1, wherein the receiving step further comprises receiving the regulatory domain information wirelessly, through a wired system, or both.

4. The method of claim 1, wherein the transmitting step further comprises transmitting the report at an interval of time shorter than the interval of time between subsequent beacon transmissions.

5. The method of claim 1, wherein the transmitting step further comprises transmitting the report independent of beacon transmissions.

6. The method of claim 1, wherein the transmitting step further comprises transmitting the report from an AP when solicited by a STA 26.

7. The method of claim 1, wherein the transmitting step further comprises an unsolicited transmission of the report.

8. The method of claim 1, further comprising transmitting in the channel based on the determining step.

9. The method of claim 1, wherein the report further comprises information on a collection of APs 24 that are candidates to which an STA 26 can roam.

10. The method of claim 1, wherein the report further comprises information on a collection of APs 24 that are candidates to which an STA 26 would prefer to roam.

11. The method of claim 1, wherein the generating step further comprises generating a report comprising at least one component corresponding to said regulatory domain information and at least one component corresponding to radar presence.

12. The method of claim 1, wherein the determining step further comprises determining whether a channel is available for transmission based, at least in part, on said component corresponding to said regulatory domain information and said component corresponding to radar presence contained in said report.

13. A method for determining available channels in a wireless network comprising:
receiving regulatory domain information within the wireless network;
generating a report comprising at least one component corresponding to said regulatory domain information and at least one component corresponding to radar presence;
transmitting said report;
receiving said report at a STA 26; and
determining whether a channel is available for transmission based, at least in part, on said component corresponding to said regulatory domain information and said component corresponding to radar presence contained in said report.

14. A method for determining available channels in a wireless network comprising:
collecting regulatory domain information in at least one channel at an AP 24;
generating a protocol frame format with at least one component corresponding to said regulatory domain information;
transmitting said protocol frame format; and
determining whether a channel is available for transmission based, at least in part, on said component corresponding to said regulatory domain information contained in said protocol frame format.

15. The method of claim 14, wherein the collecting step further comprises collecting regulatory domain information 4 measuring at least one channel, retrieving regulatory information from a local database, or applying regulatory rules on the results of the radio measurement.

16. The method of claim 14, wherein the collecting step occurs through a wired network or through a wireless network.

17. The method of claim 14, wherein the transmitting step further comprises the AP 24 transmitting the protocol frame format independent of regular beacons, either upon request by a STA or unsolicited.

18. The method of claim 14, wherein the protocol frame format further comprises information on a collection of APs 24 that are candidates to which an STA 26 can roam.

19. The method of claim 14, wherein the protocol frame format further comprises information on a collection of APs 24 that are candidates to which an STA 26 would prefer to roam.

20. A system for determining available channels in a wireless network comprising:
a memory 40, 41 containing regulatory domain information;
a transmission device 34 for transmitting the regulatory domain information within the wireless network;
a receiver 34 for receiving the regulatory domain information;
a report generator which generates a report containing at least one component corresponding to said regulatory domain information;
a transmitter 34 for transmitting said report;
a STA 26 for receiving said report; and
a processor 32 for determining whether a channel is available for transmission based, at least in part, on said component corresponding to said regulatory domain information contained in said report; and
a collection of APs 24 that are candidates to which STA 26 can roam.

21. A system for determining available channels in a wireless network comprising:
a memory 40, 41 containing regulatory domain information;
a transmission device 34 for transmitting the regulatory domain information within the wireless network;
a receiver 34 for receiving the regulatory domain information;
a detector for detecting the presence of radar;
a report generator which generates a report containing at least one component corresponding to said regulatory domain information and at least one component corresponding to radar presence;
a transmitter 34 for transmitting said report;
a STA 26 for receiving said report; and
a processor 32 for determining whether a channel is available for transmission based, at least in part, on said component corresponding to said regulatory domain information and said component corresponding to radar presence.
